(19) United States
(12) Patent Application Publication
(10) Pub. No.: US 2021/0219400 A1
(43) Pub. Date: Jul. 15, 2021

(54) CONVERSION CIRCUIT BETWEEN FLUORESCENT BALLAST AND LED

(71) Applicant: PHILIPS LIGHTING HOLDING B.V., EINDHOVEN (NL)

(72) Inventors: Bernd ACKERMANN, EINDHOVEN (NL); Christian HATTRUP, EINDHOVEN (NL)

(21) Appl. No.: 16/081,739

(22) PCT Filed: Mar. 23, 2017
(86) PCT No.: PCT/EP2017/056976

§ 371 Date: Aug. 31, 2018

(30) Foreign Application Priority Data
Mar. 31, 2016 (EP) 16163283.1

(51) Int. Cl. H05B 45/39; H05B 45/40

(52) U.S. Cl. CPC H05B 45/39; H05B 45/40

(57) ABSTRACT

The invention provides a conversion circuit for converting first signals coming from a fluorescent ballast into second signals for feeding a light circuit via a rectifier circuit, the light circuit comprising at least one light emitting diode. The conversion circuit has an inductor in a parallel branch between the two-terminal input or the two-terminal output. This enables the ballast output power be reduced without significant increase in losses. The conversion circuit is for enabling retrofit of LEDs to fluorescent ballasts.

### FIELD OF THE INVENTION

The invention relates to a conversion circuit for converting first signals coming from a fluorescent ballast into second signals for feeding a lighting circuit via a rectifier circuit. The invention further relates to a lighting circuit and to a method.

### BACKGROUND OF THE INVENTION

Solid state lighting (SSL) is rapidly becoming the norm in many lighting applications. This is because SSL elements such as light emitting diodes (LEDs) can exhibit superior lifetime and energy consumption, as well as enabling controllable light output color, intensity, beam spread and/or lighting direction.

Tubular lighting devices are widely used in commercial lighting applications, such as for office lighting, for retail environments, in corridors, in hotels, etc. A conventional tubular light fitting has a socket connector at each end for making mechanical and electrical connection to connection pins at each end of a tubular light. Conventional tubular lights are in the form of fluorescent light tubes. There is a huge installed base of luminaires equipped with electronic ballasts for fluorescent tube lamps.

There are now tubular LED (“TLED”) lamps which can be used as a direct replacement for traditional fluorescent light tubes. In this way, the advantages of solid state lighting can be obtained without the expense of changing existing light fittings. Indeed, TLEDs that are compatible with fluorescent lamp ballasts are the most straightforward and lowest cost way of replacing fluorescent lighting by LED lighting. Both rewiring (removing the ballast, connecting a TLED directly to AC mains) and replacing the whole luminaire are considerably more cumbersome and expensive. Both electromagnetic (EM) and electronic high frequency (HF) ballasts are used in fluorescent lighting.

FIG. 1 shows a typical block diagram of a TLED that is compatible with a fluorescent ballast.

The ballast 10 comprises a half-bridge parallel resonant converter and it drives an electronic (high frequency) ballast compatible TLED 12.

The ballast 10 and high frequency compatible TLED 12 are connected via the connection pins 1 and 2 at one end of the TLED and via the connection pins 3 and 4 at the other end of the TLED.

A high frequency compatible TLED 12 typically comprises all of the building blocks depicted in FIG. 1. These are a filament emulation unit 14, a pin safety and start-up circuit 16, a matching circuit 18, a rectifier 20, an LED driver 22, a smoothing capacitor 23 and the LED string 24.

For most of these building blocks, the implementations shown in FIG. 1 are just examples and other implementations of their functions are possible and are also used. The LED driver shown in FIG. 1 is a shunt switch driver.

The details of the design of the half-bridge ballast 10 are not shown in FIG. 1. This type of ballast is also just an example and other implementations such as push-pull converters are also possible and in use.

The TLED 12 comprises four connection pins that are used to connect it to the ballast 10. Pin 1 and pin 2 are located at one end of the TLED and pin 3 and pin 4 are located at the other end of the TLED. The filament emulation unit comprises first circuitry connecting pin 1 and pin 2 to a pin 5 and pin 3 and pin 4 to a pin 6. Pin safety and start-up circuit 16, matching circuit 18, and rectifier 20 are connected to the ballast only via pin 5 and pin 6.

The matching circuits 18 used in HF ballast compatible TLEDs are used to reduce the output power of the ballast. Series connected elements in the matching circuits hamper current flowing to the LED string. Parallel connected elements in the matching circuits allow for current flowing from the HF ballast to the TLED that does not reach the LED string. Adding the matching circuit 18 converts the half-bridge parallel resonant converter used in such a ballast into a higher order resonant converter. Due to the complications involved in the analysis of such higher order converters, the matching circuit is probably the least well understood part of the TLED circuitry. Different matching circuits have been described in conference and journal papers and in the patent literature.

FIG. 2 shows in a simplified block diagram how the matching circuit 18 is located in the TLED between the ballast 10 and the other TLED circuitry (rectifier 20, smoothing capacitor 23 and LEDs 24). The filament emulation, pin safety and startup circuitry, and LED driver are not shown in this simplified block diagram. Their influence on the output power of the ballast is almost negligible. The matching circuit 18 is thus a two-port network connected via a first port comprising pin 5 and pin 6 to the ballast and via a second port comprising pin 7 and pin 8 to the rectifier. Series elements are connected between pins 5 and 7 or between pins 6 and 8. Parallel elements are connected between pins 5 and 6 or between pins 7 and 8. Thus, series and parallel elements may be defined by requiring that, if all series-connected elements are replaced by a short circuit and all parallel-connected elements are replaced by an open circuit, pin 5 is then connected to pin 7, pin 6 is connected to pin 8, and there is no connection between pin 5 and pin 6.

Tubular lamp ballasts are approximate current sources. Therefore they can drive LED strings with approximately constant power. Such a circuit is depicted in FIG. 3 without any matching circuit. The use of a matching (or conversion) circuit enables shaping the load impedance seen by the ballast which is used for achieving compatibility with a range of different ballast types.

There are many different examples of known matching circuit.

FIG. 4 shows an example based on EP 2 178 345 in which a series-connected capacitor 40 between the ballast and the rectifier 20 implements a matching circuit.

WO 2013/164739 discloses the use of a series connected inductor 50 as the matching circuit as shown in FIG. 5 and alternatively the use of parallel connected capacitors 60 as shown in FIG. 6.

FIG. 7 is based on a design disclosed in Nan Chen, Henry Shu-Hung Chung, “A driving technology for retrofit LED lamp for fluorescent lighting fixtures with electronic ballasts”, 2010 IEEE Second Annual Energy Conversion Congress and Exposition (ECCE), 441-448. The matching circuit comprises a series input capacitor 70, parallel capacitor 72 and series output inductor 74.

FIG. 8 is based on a design disclosed in Hyun-Jae Kim, Byung-Hun Lee, Chun-Taek Rim, “Passive LED driver compatible with rapid-start ballast”, 2011 IEEE 8th International Conference on Power Electronics and ECCE Asia (ICPE & ECCE), 507-514. The matching circuit comprises a series inductor 80 and parallel capacitor 82.

FIG. 9 is based on a design disclosed in Nan Chen, Henry Shu-Hung Chung, “An LED lamp driver compatible with low- and high-frequency sources”, IEEE Transactions on Power Electronics, Vol. 28, No. 5, May 2013, 2551-2568. The matching circuit comprises a series input inductor 90, parallel capacitor 92 and series output inductor 94.

WO 2014/009836 discloses a design as shown in FIG. 10, in which the matching circuit comprises a parallel capacitor 100 and a series inductor 102.

The output power of a ballast is reduced by a factor of about two when replacing a fluorescent tubular lamp by an equivalent TLED (with approximately same illuminance at the surfaces illuminated). The light generating efficiency of commercially available LEDs is expected to still increase significantly in the near future. A further reduction of ballast output power will then be needed. Furthermore, future smart connected TLED applications will require deep dimming of the TLEDs and thus significant reduction of ballast output power.

TLEDs using known matching circuits are thus operating at the limit with respect to reducing ballast output power. Further reduction of ballast output power results in a significant increase of losses in the ballast, currents flowing in the ballast, and voltages at the ballast output. As a consequence of this, ballast lifetime is severely reduced.

There is therefore a need for an improved conversion circuit between the existing ballast and a tubular LED so that the ballast output power can be dropped further and in a power efficient manner.

### SUMMARY OF THE INVENTION

The invention is defined by the claims.

According to examples in accordance with an aspect of the invention, there is provided a conversion circuit for converting first signals coming from a fluorescent ballast having a pair of electrical connections at a first end and a pair of electrical connections at an opposite second end into second signals for feeding a light circuit via a rectifier circuit, the light circuit comprising at least one light emitting diode, the conversion circuit comprising:

a two-terminal input for receiving the first signals comprising a first input terminal and a second input terminal;

the first input terminal being for connection to the pair of electrical connections at the first end of the ballast;

the second input terminal being for connection to the pair of electrical connections at the second end of the ballast;

a two-terminal output for supplying the second signals comprising a first output terminal and a second output terminal; and

a reactive stage for coupling the output to the input, wherein the reactive stage comprises an inductor in a parallel branch.

The reactive stage enables a relatively simple conversion circuit to be created. Such a conversion circuit is relatively low-cost and relatively robust. The use of a parallel inductor within the conversion circuit enables the ballast output power to be reduced to much lower levels than previously possible. A parallel connected inductor in the matching circuits allows for current flowing from the HF ballast to the light circuit that does not reach the lighting elements (e.g. LED string). The current flowing through the inductor accounts for reactive ballast output power whilst the current flowing through the LED string accounts for active ballast power. To a certain degree the same effect can also be achieved with a parallel capacitor which is the concept being used in state-of-the-art matching circuits. However, when trying to decrease ballast output power below levels that have been investigated so far, then parallel connected capacitors disturb the behavior of the resonant circuits in some HF ballasts in an unfavorable way resulting in increased losses in the ballast. Using parallel inductances in matching circuits is compatible with a significantly broader range of different HF ballast types. It is especially possible to achieve compatibility with both self-oscillating and IC controlled ballasts. In particular, the ballast output power can be reduced down to almost zero without increasing losses in the ballast, or losses arising from currents flowing in the ballast, or losses arising from the voltage at the ballast output. This is especially interesting for deep dimming of TLEDs for example in smart connected applications.

The pair of electrical connections at the first end of the ballast are the sockets at one end of a tubular lamp fitting, for receiving the pins of one end of a tubular lamp such as a tubular LED. The pair of electrical connections at the second end of the ballast are the sockets at the other end of the tubular lamp fitting, for receiving the pins of the other end of the tubular lamp.

The conversion circuit is preferably housed with a tubular lamp, such as a tubular LED, which is for connection to the tubular lamp fitting, which includes a ballast circuit.

The reactive circuit introduces a reactive transfer function between the input and the output.

In a first example, the reactive stage comprises:

an inductor between the terminals of the two-terminal input, and the two terminals of the two-terminal input are connected to the two terminals of the two-terminal output.

This provides a simple circuit of a parallel inductor.

In a second example, the reactive stage comprises:

an inductor between the terminals of the two-terminal input and a series inductor between the first or second terminals of the two-terminal input and output.

This provides a combination of a parallel input inductor and a series output inductor.

In a third example, the reactive stage comprises:

an inductor between the terminals of the two-terminal input and a series capacitor between the first or second terminals of the two-terminal input and output.

This provides a combination of a parallel inductor and a series capacitor.

In a fourth example, the reactive stage comprises:

an inductor between the first or second terminals of the two-terminal input and output, and an inductor between the two terminals of the two-terminal output.

This provides a combination of a series inductor and a parallel output inductor.

In a fifth example, the reactive stage comprises:

a capacitor between the first or second terminals of the two-terminal input and output, and an inductor between the two terminals of the two-terminal output.

This provides a combination of a series capacitor and a parallel output inductor.

In a sixth example, the reactive stage comprises:

an inductor between the terminals of the two-terminal input and a capacitor between the terminals of the two-terminal input, and the two terminals of the two-terminal input are connected to the two terminals of the two-terminal output.

This provides a combination of a parallel inductor and a parallel capacitor.

In a seventh example, the reactive stage comprises:

an inductor and a capacitor in series between the terminals of the two-terminal input, and wherein the two terminals of the two-terminal input are connected to the two terminals of the two-terminal output.

This provides a combination of the parallel inductor in a branch with a series capacitor.

The conversion circuit functions as a matching circuit for reducing an amplitude of one or more of the first and second signals.

The invention also provides a fluorescent ballast comprising the conversion circuit as defined above.

The invention also provides a lighting circuit comprising:

the conversion circuit as defined above; and

a lighting circuit comprising at least one light emitting diode.

The lighting circuit may further comprise:

a filament emulation circuit;

a pin safety and start-up circuit;

a rectifier;

an output capacitor at the output of the rectifier; and

an LED driver, wherein the rectifier is at an output side of the conversion circuit.

The invention also provides a lighting installation comprising:

a ballast; and

a lighting circuit defined above.

The ballast may be a half-bridge ballast.

The invention also provides a method for replacing a discharge lamp by a lighting circuit comprising at least one light emitting diode, the method comprising a step of installing a conversion circuit as defined above between a fluorescent ballast and the lighting circuit.

### BRIEF DESCRIPTION OF THE DRAWINGS

Examples of the invention will now be described with reference to the accompanying drawings, in which:

FIG. 1 shows a typical block diagram of a TLED that is compatible with a fluorescent ballast;

FIG. 2 shows in a simplified block diagram how the matching circuit is located in the TLED between the ballast and the other TLED circuitry;

FIG. 3 shows a tubular LED driven by a ballast without any matching (i.e., conversion) circuit;

FIG. 4 shows a first known example of conversion circuit;

FIG. 5 shows a second known example of conversion circuit;

FIG. 6 shows a third known example of conversion circuit;

FIG. 7 shows a fourth known example of conversion circuit;

FIG. 8 shows a fifth known example of conversion circuit;

FIG. 9 shows a sixth known example of conversion circuit;

FIG. 10 shows a seventh known example of conversion circuit;

FIG. 11 shows a first example of a conversion circuit used in a lighting installation;

FIG. 12 shows a second example of a conversion circuit used in a lighting installation;

FIG. 13 shows a third example of a conversion circuit used in a lighting installation;

FIG. 14 shows a fourth example of a conversion circuit used in a lighting installation;

FIG. 15 shows a fifth example of a conversion circuit used in a lighting installation;

FIG. 16 shows a sixth example of a conversion circuit used in a lighting installation;

FIG. 17 shows a seventh example of a conversion circuit used in a lighting installation;

FIG. 18 shows performance graphs of a first conversion circuit based on the layout of FIG. 12 when connected to a self-oscillating ballast;

FIG. 19 shows performance graphs of a first conversion circuit based on the layout of FIG. 12 when connected to an IC controlled ballast;

FIG. 20 shows performance graphs of a second conversion circuit based on the layout of FIG. 12 when connected to a self-oscillating ballast;

FIG. 21 shows performance graphs of a second conversion circuit based on the layout of FIG. 12 when connected to an IC controlled ballast;

FIG. 22 shows performance graphs of a third conversion circuit based on the layout of FIG. 12 when connected to a self-oscillating ballast; and

FIG. 23 shows performance graphs of a third conversion circuit based on the layout of FIG. 12 when connected to an IC controlled ballast.

### DETAILED DESCRIPTION OF EMBODIMENTS

The invention provides a conversion circuit for converting first signals coming from a fluorescent ballast into second signals for feeding a light circuit via a rectifier circuit, the light circuit comprising at least one light emitting diode. The conversion circuit has an inductor in a parallel branch between a two-terminal input or a two-terminal output. This enables the ballast output power be reduced without significant increase in losses. The conversion circuit is for enabling retrofit of LEDs to fluorescent ballasts.

At the limit small inductors function as a short circuit, whereas large inductors function as an open circuit. Small capacitors function as an open circuit, and large capacitors function as a short circuit.

Impedance values in tubular lighting devices may vary between small values of a few Ohms in the filaments to hundreds of Ohms between the ends of a burning lamp. With operating frequencies of TLEDs between about 20 kHz and 60 kHz, this corresponds to inductance values between about 3 μH and 3000 μH and capacitance values between about 2 nF and 2000 nF being suitable for use in the matching circuits.

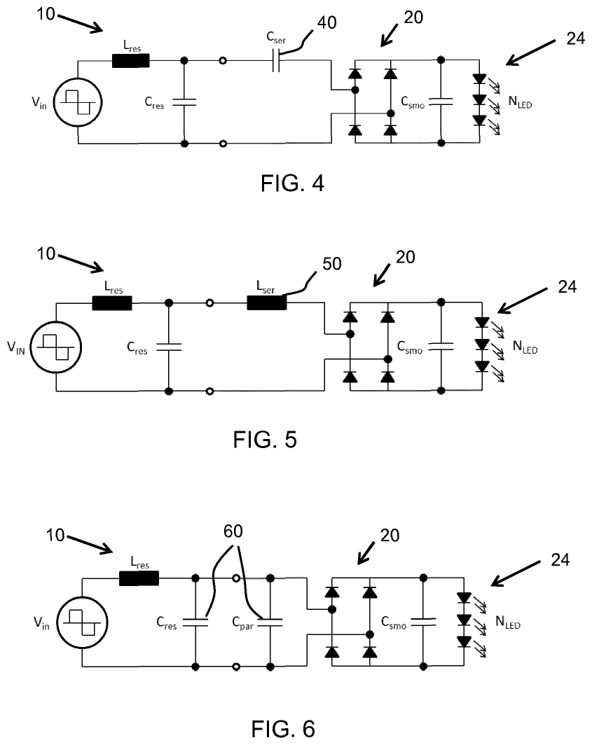

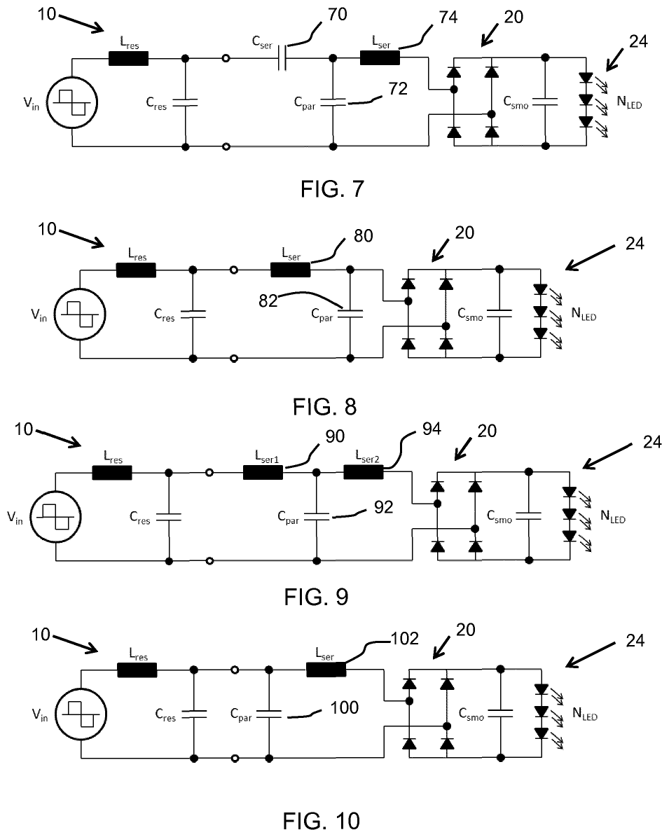

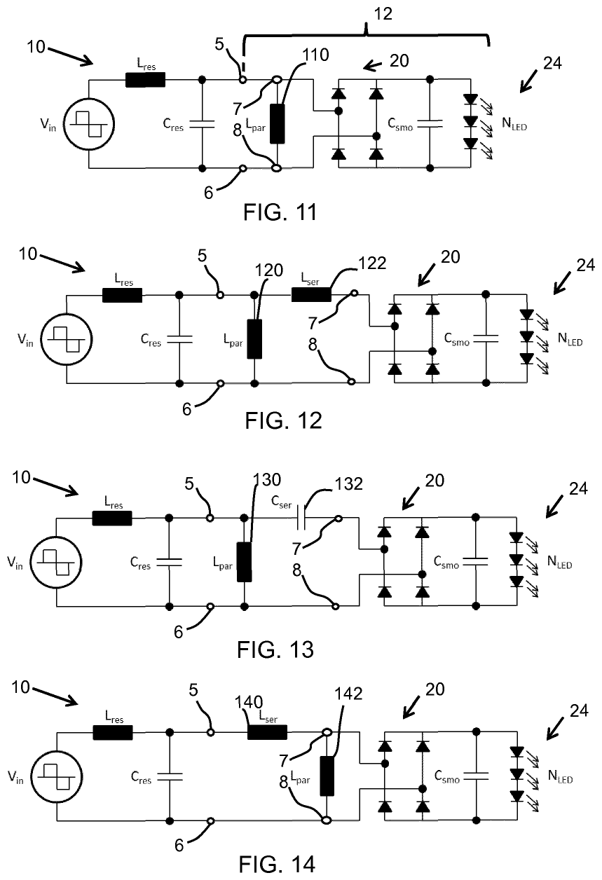

As in FIGS. 2 to 10, the examples of FIGS. 11 to 17 show a ballast 10 in the form of a half-bridge parallel resonant converter, the matching (conversion) circuit which is the subject of the invention, the rectifier 20, buffer capacitor and LEDs 24. Other components, such as a filament emulation unit, a pin safety and start-up circuit and an LED shunt switch driver are not shown in order to keep the diagrams simple.

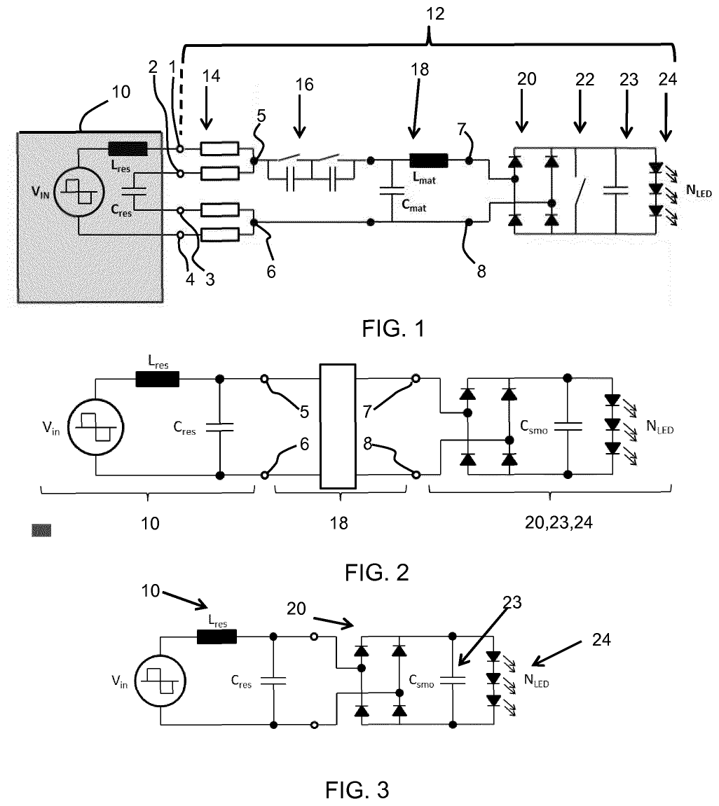

In all examples, the conversion circuit comprises a two-terminal input 5, 6 for receiving first signals from the ballast and a two-terminal output 7, 8 for supplying second signals to the rectifier. The first input terminal 5 is connected to the pins at one end of the TLED, and the second input terminal 6 is connected to the pins at the other end of the TLED in the manner shown in FIG. 1. The first input terminal is in particular connected to the two terminals 1,2 at one end of the lamp housing via a first part of the filament emulation circuit 14, and the second input terminal is in particular connected to the two terminals 3,4 at the other end of the lamp housing via a second part of the filament emulation circuit 14. Terminals 1,2 are at one end of the tubular LED lamp 12, and the terminals 3,4 are at the other end of the tubular LED lamp 12.

The filament emulation circuit is now shown in FIGS. 11 to 17, hence the indirect coupling between the two input terminals 5,6 to the four pins of the TLED (and hence the four sockets of the lamp housing) is not shown. Reference is instead made to FIG. 1, although it is noted that other circuit couplings between the terminals 1,2,3,4,5,6 are possible.

The two terminal output 7,8 forms the rectifier input. The two-terminal input has a first input terminal 5 and a second input terminal 6, and the two-terminal output has a first output terminal 7 and a second output terminal 8. The conversion circuit is a reactive stage having an inductor in a parallel branch.

In a first example shown in FIG. 11, the reactive stage comprises an inductor 110 between the terminals of the two-terminal input, and the two terminals of the two-terminal input are connected to the two terminals of the two-terminal output. Thus, there are no series elements.

This provides a simple circuit of a parallel inductor across the input and output.

In a second example shown in FIG. 12, the reactive stage comprises a first inductor 120 between the terminals of the two-terminal input and a second, series inductor 122 between a first terminal of the two-terminal input and a corresponding first terminal of the two-terminal output.

This provides a combination of a parallel input inductor and a series output inductor.

In a third example shown in FIG. 13, the reactive stage comprises an inductor 130 between the terminals of the two-terminal input and a series capacitor 132 between the first terminal of the two-terminal input and the corresponding first terminal of the two-terminal output.

This provides a combination of a parallel inductor and a series output capacitor.

In a fourth example shown in FIG. 14, the reactive stage comprises a first inductor 140 between the first terminal of the two-terminal input and the corresponding first terminal of the two-terminal output, and a second inductor 142 between the two terminals of the two-terminal output.

This provides a combination of a series input inductor and a parallel output inductor.

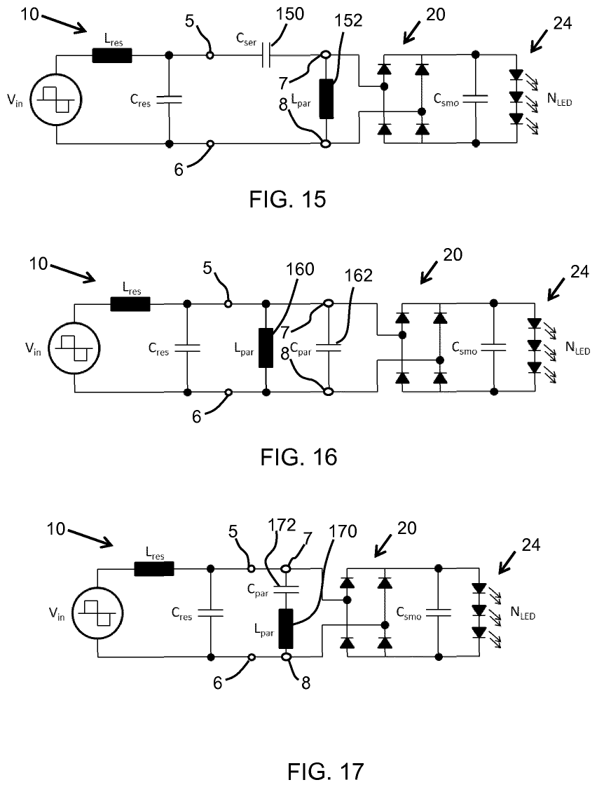

In a fifth example shown in FIG. 15, the reactive stage comprises a capacitor 150 between the first terminal of the two-terminal input and the corresponding first terminal of the two-terminal output, and an inductor 152 between the two terminals of the two-terminal output.

This provides a combination of a series input capacitor and a parallel output inductor.

In a sixth example shown in FIG. 16, the reactive stage comprises an inductor 160 between the terminals of the two-terminal input and a capacitor 162 between the terminals of the two-terminal input, and the two terminals of the two-terminal input are connected to the two terminals of the two-terminal output.

This provides a combination of a parallel inductor and a parallel capacitor. In a seventh example shown in FIG. 17, the reactive stage comprises an inductor 170 and a capacitor 172 in series between the terminals of the two-terminal input, and wherein the two terminals of the two-terminal input are connected to the two terminals of the two-terminal output.

This provides a combination of the parallel inductor in a branch with a series capacitor.

The conversion circuit functions as a matching circuit for reducing an amplitude of one or more of the first and second signals.

The conversion circuit may be combined with the ballast to create a modified fluorescent ballast. The overall circuits as shown in FIGS. 11 to 17 comprise a lighting circuit coupled to a ballast by means of a conversion circuit. The combination of the ballast, conversion circuit and lighting circuit may be considered to constitute a lighting installation.

In order to replace a discharge lamp by a lighting circuit comprising at least one light emitting diode, a conversion circuit as described above is installed between between a fluorescent ballast and the lighting circuit.

Only one type of ballast has been described above, but there are many different types. In general, an electrical ballast is a device intended to limit the amount of current in an electric circuit. Typically, an inductive ballast is used in AC fluorescent lamps, to limit the current through the tube, which would otherwise rise to destructive levels due to the negative differential resistance artifact in the voltage-current characteristic.

An inductor is very common in line-frequency ballasts to provide the proper starting and operating electrical condition to power a fluorescent lamp, neon lamp, or high intensity discharge (HID) lamp. The reactance limits the power available to the lamp with only minimal power losses in the inductor, and the voltage spike produced when current through the inductor is rapidly interrupted is used in some circuits to first strike the arc in the lamp.

A capacitor may often be paired with the inductor to improve the power factor. For large lamps, line voltage may not be sufficient to start the lamp, so an autotransformer winding is included in the ballast to step up the voltage. The autotransformer is designed with enough leakage inductance so that the current is appropriately limited.

Because of the large inductors and capacitors that must be used, reactive ballasts operated at line frequency tend to be large and heavy. They commonly also produce noise.

An electronic ballast instead uses solid state electronic circuitry to provide the proper starting and operating electrical conditions to power discharge lamps. An electronic ballast can be smaller and lighter than a comparably-rated magnetic one as described above. An electronic ballast is also quieter. Electronic ballasts typically use a switch mode power supply, first rectifying the input power and then chopping it at a high frequency. Advanced electronic ballasts may also allow dimming via pulse-width modulation or via changing the frequency to a higher value.

Ballasts incorporating a microcontroller (digital ballasts) may offer remote control and monitoring via networks or simple analog control using a 0-10 V DC brightness control signal.

Electronic ballasts usually supply power to the lamp at a frequency of 20,000 Hz or higher, rather than the mains frequency of 50-60 Hz. This substantially eliminates the stroboscopic effect of flicker. With the higher efficiency of the ballast itself and the higher lamp efficacy at higher frequency, electronic ballasts offer higher system efficacy. The ballast implements other functions beyond current limitation, such as an instant start function using a relatively high voltage, or a rapid start function in which cathode heating is used.

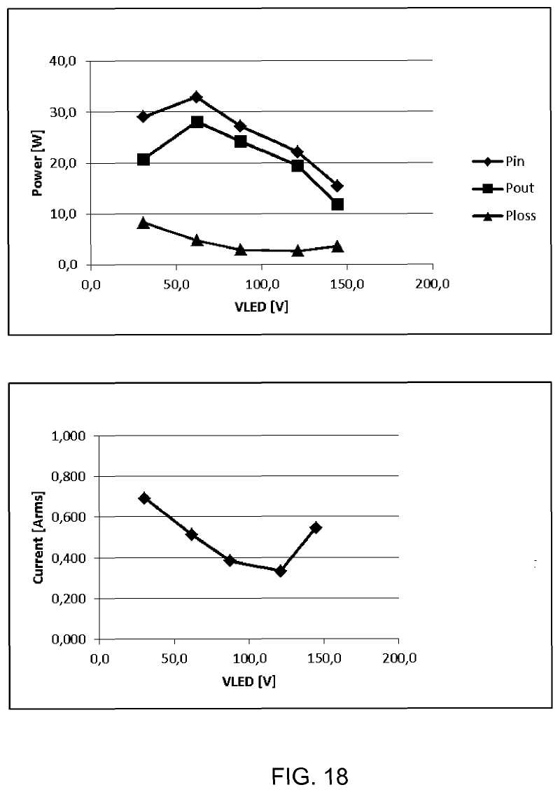

The conversion circuit of the invention may be used for various different known high frequency electronic ballast circuits. It is especially possible to design matching circuits that can be used for both self-oscillating and IC controlled ballasts. The invention enables a reduction in the ballast output power down to very low values without increasing (or even with decreasing) ballast power and/or ballast output current. These advantages have been demonstrated for some of the matching circuits by measurements shown in FIGS. 18 to 23.

In each case, the top plot shows the input power (Pin), the output power (Pout) and the power loss (Ploss) as a function of the LED forward voltage. The bottom plot shows the output current from the ballast, again as a function of the LED forward voltage.

At small values of the LED forward voltage, the ballast acts as an approximate current source for the LEDs and power increases in proportion to the LED forward voltage. Large values of the LED forward voltage keep current from flowing through the LED string and force it to flow through parallel elements in the matching circuit or through the output capacitor of the ballast. As a consequence of this, the LED power reduces down to zero. Operating in this regime is however only possible if the currents flowing through other parts of the system stay at reasonably small values.

Note that FIGS. 18 to 23 are each for one specific set of values for the components of the matching circuit. The component values will however be selected according to the required circuit functionality. As explained above, the inductance values used typically range between 3 μH and 3000 μH and the capacitance values typically range between 2 nF and 2000 nF.

FIG. 18 shows the results for a self-oscillating ballast with a 940 μH parallel inductor and a 1 μF series inductor matching circuit (as in FIG. 12).

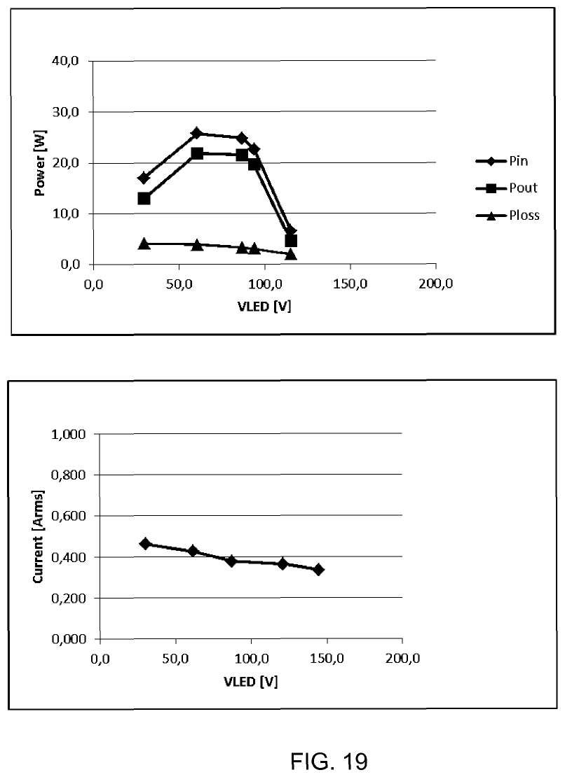

FIG. 19 shows the results for an IC-controlled ballast with 940 μH parallel inductor and 1 μF series inductor matching circuit (as in FIG. 12).

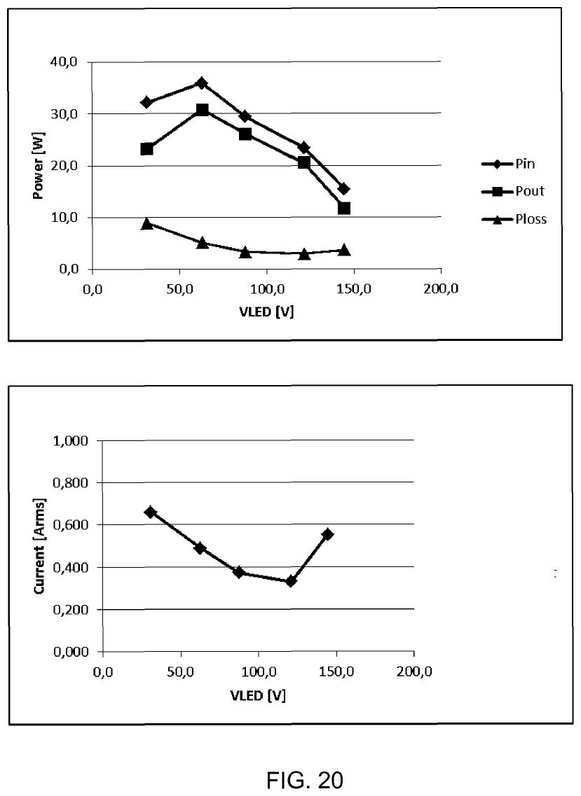

FIG. 20 shows the results for a self-oscillating ballast with a 940 μH parallel inductor and a 100 nF series inductor matching circuit (as in FIG. 12).

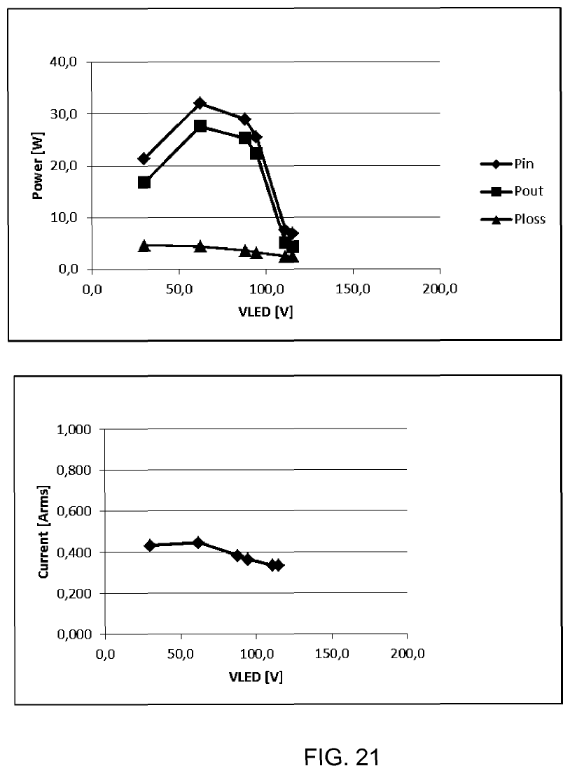

FIG. 21 shows the results for an IC-controlled ballast with a 940 μH parallel inductor and a 100 nF series inductor matching circuit (as in FIG. 12).

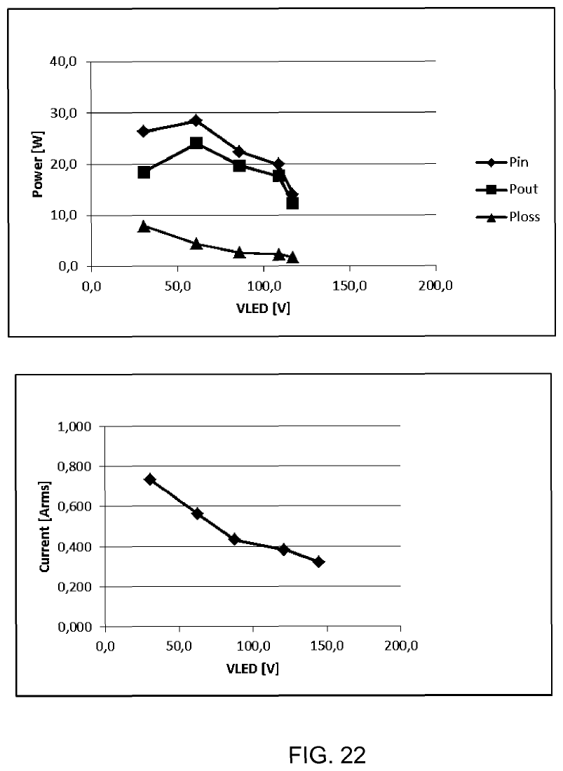

FIG. 22 shows the result for a self-oscillating ballast with a 940 μH parallel inductor and 100 μH series inductor matching circuit (as in FIG. 12).

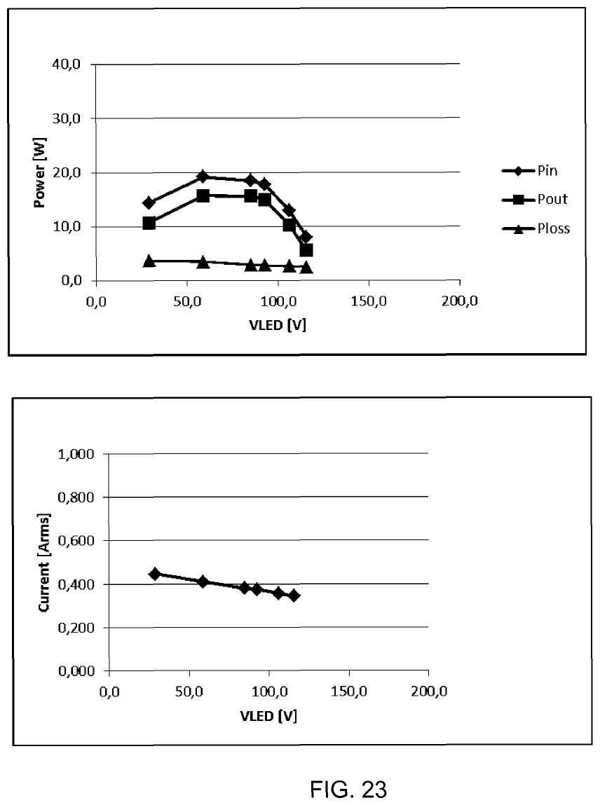

FIG. 23 shows the results for an IC-controlled ballast with a 940 μH parallel inductor and 100 μH series inductor matching circuit (as in FIG. 12).

In the examples shown, series connected elements shown between the first input/output terminals 5 and 7. However, series elements may equally be provided between the second input/output terminals 6 and 8. Current flowing out of the first input terminal 5 flows back into the second input terminal 6. Current flows through a series connected element irrespective of whether it is connected to terminal 5 or 6.

Examples have been given based on matching circuits with one or two elements. Matching circuits with three and more elements are also possible, e.g. a parallel inductor with its lower end connected directly to terminal 6 and terminal 8 and its upper end connected to terminal 5 via a reactive element and also connected to terminal 7 via another reactive element. Thus, more complicated matching circuits are also possible.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A conversion circuit for converting first signals coming from a fluorescent ballast, having a pair of electrical connections at a first end and a pair of electrical connections at an opposite second end, into second signals for feeding a light circuit via a rectifier circuit, the light circuit comprising at least one light emitting diode, the conversion circuit comprising:
a two-terminal input for receiving the first signals comprising a first input terminal and a second input terminal;
the first input terminal being for connection to the pair of electrical connections at the first end of the ballast;
the second input terminal being for connection to the pair of electrical connections at the second end of the ballast;
a two-terminal output for supplying the second signals comprising a first output terminal and a second output terminal; and
a reactive stage for coupling the two terminal output to the two-terminal input, wherein the reactive stage comprises an inductor in a parallel branch, wherein the inductor is a parallel element that is coupled between the first input terminal 5 and the second input terminal 6 or coupled between the first output terminal 7 and the second output terminal 8.

2. A conversion circuit as claimed in claim 1, wherein the reactive stage comprises:
a parallel inductor between the terminals of the two-terminal input, and the two terminals of the two-terminal input are connected to the two terminals of the two-terminal output.

3. A conversion circuit as claimed in claim 1, wherein the reactive stage comprises:
a parallel inductor between the terminals of the two-terminal input and a series inductor between the first terminals or second terminals of the two-terminal input and output.

4. A conversion circuit as claimed in claim 1, wherein the reactive stage comprises:
a parallel inductor between the terminals of the two-terminal input and a series capacitor between the first terminals or second terminals of the two-terminal input and output.

5. A conversion circuit as claimed in claim 1, wherein the reactive stage comprises:
a series inductor, between the first terminals or second terminals of the two-terminal input and output, and a parallel inductor between the two terminals of the two-terminal output.

6. A conversion circuit as claimed in claim 1, wherein the reactive stage comprises:
a series capacitor between the first terminals or second terminals of the two-terminal input and output, and a parallel inductor between the two terminals of the two-terminal output.

7. A conversion circuit as claimed in claim 1, wherein the reactive stage comprises:
a parallel inductor between the terminals of the two-terminal input and a capacitor between the terminals of the two-terminal input, and the two terminals of the two-terminal input are connected to the two terminals of the two-terminal output.

8. A conversion circuit as claimed in claim 1, wherein the reactive stage comprises:
an inductor and a capacitor in series between the terminals of the two-terminal input, and wherein the two terminals of the two-terminal input are connected to the two terminals of the two-terminal output.

9. A conversion circuit as claimed in claim 1, wherein the conversion circuit comprises a matching circuit for reducing an amplitude of one or more of the first and second signals.

10. A fluorescent ballast comprising the conversion circuit as claimed in claim 1.

11. A lighting circuit comprising:
a conversion circuit as claimed in claim 1; and
a lighting circuit comprising at least one light emitting diode.

12. A lighting circuit as claimed in claim 11 comprising:
a filament emulation circuit;
a pin safety and startup circuit;
a rectifier;
an output capacitor at the output of the rectifier; and
an LED driver, wherein the rectifier is at an output side of the conversion circuit.

13. A lighting installation comprising:
a fluorescent ballast; and
a lighting circuit as claimed in claim 12, wherein the conversion circuit is an output side of the ballast.

14. A lighting installation as claimed in claim 13, wherein the fluorescent ballast comprises half bridge resonant ballast.

15. A method for replacing a discharge lamp by a lighting circuit comprising at least one light emitting diode, the method comprising a step of installing a conversion circuit as claimed in claim 1 between a fluorescent ballast and the lighting circuit.
